(19) United States
(12) Patent Application Publication
(10) Pub. No.: US 2016/0121195 A1
(43) Pub. Date: May 5, 2016

(54) PORTABLE STATUS INDICATOR

(71) Applicant: Michael Brown, Layton, UT (US)

(72) Inventor: Michael Brown, Layton, UT (US)

(21) Appl. No.: 14/932,735

(22) Filed: Nov. 4, 2015

Related U.S. Application Data
(60) Provisional application No. 62/075,116, filed on Nov. 4, 2014.

(51) Int. Cl. A63B 71/06; G09F 13/22; G09F 13/00

(52) U.S. Cl. CPC A63B 71/0619; G09F 13/005; G09F 13/22; A63B 2071/0694; G09F 2013/222

(57) ABSTRACT

A portable status indicator apparatus includes a display unit, a display element, and an elongate shaft. The display unit has a plurality of display regions that are cumulatively viewable from 360 degrees around the display unit. The display element has a plurality of actuatable indicators for displaying a status relating to an event. Each actuatable indicator of the plurality of actuatable indicators is coupled to a display region of the plurality of display regions. The elongate shaft has a top end and a bottom end and the display unit is coupled to the top end.

### CROSS-REFERENCE TO RELATED APPLICATION

This application claims the benefit of U.S. Provisional Patent Application No. 62/075,116, filed Nov. 4, 2014, which is incorporated herein by reference.

### FIELD

The subject matter of the present disclosure relates generally to portable status indicators.

### BACKGROUND

Most conventional signs and markers only display information on two opposing sides of a surface. For example, most markers that indicate a status of an event, such as a down marker at a football game, only display event information on two opposing sides of the marker. Such conventional markers are generally visible by portions of a crowd attending the event that are positioned/seated to face one of the two sides of the marker, but other portions of the crowd that are not directly facing one of the two sides of the marker are often unable to clearly view and discern the information displayed on the marker. Such markers are particularly poorly suited for events where where crowds are positioned 360 degrees around the marker, as only portions of the attending crown are able to clearly view the information of the conventional two-dimensional marker.

### SUMMARY

From the foregoing discussion, it should be apparent that a need exists for an apparatus, system, and method for status indication that overcome many or all of the limitations of conventional signs. Beneficially, such an apparatus, system, and method would improve the ease, efficiency, and effectiveness of indicating statuses relating to an event. The subject matter of the present application has been developed in response to the present state of the art, and in particular, in response to the problems and needs in the art that have not yet been fully solved by currently available signs. Accordingly, the present disclosure has been developed to provide an apparatus, system, and method that overcome many or all of the above-discussed shortcomings in the art.

Disclosed herein is one embodiment of a portable status indicator apparatus that includes a display unit, a display element, and an elongate shaft. The display unit has a plurality of display regions that are cumulatively viewable from 360 degrees around the display unit. The display element has a plurality of actuatable indicators for displaying a status relating to an event. Each actuatable indicator of the plurality of actuatable indicators is coupled to a display region of the plurality of display regions. The elongate shaft has a top end and a bottom end and the display unit is coupled to the top end.

According to one implementation, the bottom end of the elongate shaft is engageable at a certain location across a ground surface. In such an implementation, the status of the event is a first status of the event and the certain location of the bottom end of the elongate shaft across the ground surface relates to a second status of the event. For example, the event may be a football game and the first status may be a ‘down’ of a football play and the second status may be a position of the line of scrimmage of the football play.

In other implementations, the bottom end of the elongate shaft includes a gripping element for gripping the ground surface. In another implementation, the elongate shaft has a telescoping structure such that the elongate shaft is collapsible or the elongate shaft has a folding structure such that the elongate shaft is foldable. In one implementation, the elongate shaft is detachably coupled to the display unit. The display element may be a plurality of light emitting diodes (“LED” s) or a plurality of LED panels. In another implementation, the display element includes multiple electronic screens. The LEDs or screens may be powered by one or more of a battery and a solar panel, the solar panel being disposed on a top of the display unit. In one implementation, the plurality of LEDs are recessed in relation to an exterior surface of the display unit such that the LEDs do not protrude beyond the exterior surface. In one implementation, the display element is a plurality of slats controlled by a lever. In another implementation, the display element is a banner that wraps around each display region.

According to some implementations, the display unit has a substantially cubical shape with a top side, a bottom side, and four lateral sides perpendicular to the top and bottom sides. Each lateral side of the four lateral sides may be a display region of the plurality of display regions. In such an implementation, the top side may also be a display region of the plurality of display regions. In one implementation, the apparatus further includes a controller configured to receive instructions and control the plurality of actuatable indicators based on the instructions. For example, the controller may receive the instructions wirelessly from one or more control entities. In another implementation, the display element displays multiple statuses relating to an event and each status may be specific to one or more of the display regions.

Also disclosed herein is another embodiment of a portable status indicator apparatus. In such an embodiment, the portable status indicator apparatus includes a display unit having a plurality of display regions. The apparatus also includes a display element having a plurality of actuatable indicators for displaying multiple statuses relating to an event, with each actuatable indicator of the plurality of actuatable indicators being coupled to a display region of the plurality of display regions. In such a configuration, each status is specific to one or more of the display regions. The apparatus also includes an elongate shaft having a top end and a bottom end, with the display unit being coupled to the top end. The apparatus also includes a controller configured to receive instructions from one or more control entities to control the plurality of actuatable indicators in displaying the multiple statuses. Each status is specific to one or more of the control entities.

According to another embodiment, the present disclosure includes a method for indicating one or more statuses relating to an event. The method includes moving a portable status indicator apparatus to a desired position relative to a ground surface of the event. For example, the method may include moving the portable status indicator apparatus to a desired position along a sideline of a football field, with the desired position along the sideline indicating the position of the line of scrimmage (i.e., a status of the event). The portable status indicator apparatus includes a display unit coupled to a top end of an elongate shaft. The method further includes engaging a bottom end of the elongate shaft of the portable status indicator apparatus with the ground surface at the desired position and actuating a plurality of actuatable indicators to display the one or more statuses relating to the event. Each of the actuatable indicators of the plurality of actuatable indicators is coupled to a display region of the display unit and the display regions are cumulatively viewable from 360 degrees around the display unit.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the subject matter disclosed herein. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize that the subject matter of the present application may be practiced without one or more of the specific features or advantages of a particular embodiment. In other instances, additional features and advantages may be recognized in certain embodiments that may not be present in all embodiments of the disclosure. Further, in some instances, well-known structures, materials, or operations are not shown or described in detail to avoid obscuring aspects of the subject matter of the present disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a perspective view of one embodiment of a status indicator apparatus;

FIG. 2 is a perspective view of another embodiment of the status indicator apparatus;

FIG. 3 is a perspective view of another embodiment of the status indicator apparatus;

FIG. 4 is a perspective view of yet another embodiment of the status indicator apparatus; and

FIG. 5 is a schematic flowchart diagram of one embodiment of a method for indicating one or more statuses relating to an event.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

In the following description, numerous specific details are provided. One skilled in the relevant art will recognize, however, that the subject matter of the present application may be practiced without one or more of the specific details, or with other methods, components, materials, and so forth. In other instances, well-known structures, materials, or operations are not shown or described in detail to avoid obscuring aspects of the disclosure.

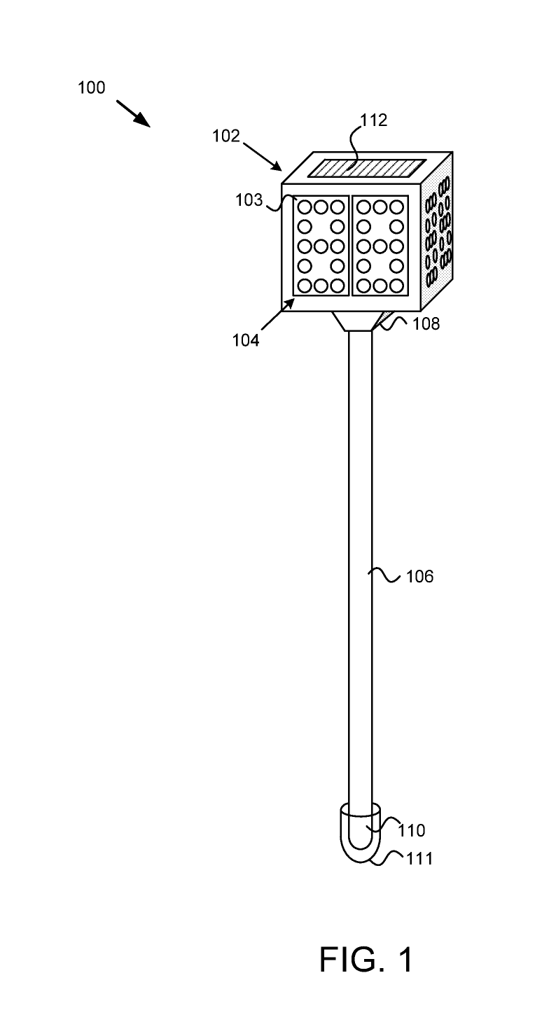

FIG. 1 is a perspective view of one embodiment of a status indicator apparatus 100. The apparatus 100 includes a display unit 102, a display element 104, and an elongate shaft 106. In general, the display unit 102 has a plurality of display regions 103 that are cumulatively viewable from 360 degrees around the apparatus 100. In other words, the display regions 103 may be surfaces or surface regions of a 3-dimensional display unit 102. The apparatus 100 further includes a display element 104 that includes a plurality of actuatable indicators relating to a status of an event. Each actuatable indicator of the plurality of actuatable indicators is coupled to a display region of the plurality of display regions 103 of the display unit 102. As described in greater detail below, each actuatable indicator may include, for example, an array of visible features, such as light emitting diodes (LED's). The elongate shaft 106 of the apparatus 100 includes a top end 108 and a bottom end 110. In general, the apparatus 100 may be implemented to indicate at least a first status of an event to a crowd positioned/seated 360 degrees around the apparatus 100, with at least a substantial majority of the crowd on all sides of the apparatus 100 able to view the actuatable indicators of the display element 104.

In one embodiment, the display unit 102 has a cube shape and includes display regions 103 on each of the four lateral surfaces extending between a top surface and a bottom surface. Each display region 103 may be a section of each lateral surface. For example, the display regions 103 may be panels to which the display elements may be coupled. Each actuatable indicator of the display element 104 may be coupled to each display region 103. In one embodiment, each actuatable indicator may include an array of display features. For example, each actuatable indicator may include one or more panels of LEDs. In one embodiment, the display regions 103 may be recessed and the LEDs may be coupled to the recessed display regions 103. The LEDs may be configured to have a standard configuration, such as a figure eight shape that allows the LEDs to be actuated to display numerals 0-9. In one embodiment, each actuatable indicator may include multiple figure eight LED panels to allow the display element 104 to display longer or more complex statuses. In another embodiment, the display element includes electrical screens (LCD, etc.) that can be disposed on the sides of the display unit.

In one embodiment, the apparatus 100 may include an integrated power source, such as a battery, to power the display element. The power source may be rechargeable and/or replaceable and may be housed within the display unit 102 or may be housed within or coupled to the elongate shaft 106. In another embodiment, the apparatus 100 may include a solar panel 112 that is configured to directly power the display element 104 or that is configured to charge (or at least provide supplemental charge to) the power source. The characteristics and specifications of the power source may be dependent on the type of display element. In another embodiment, the apparatus may include an electrical power interface and/or an integrated power cord that may be connected to an electrical outlet.

The elongate shaft 106, as described above, has a top end 108 and a bottom end 110. The top end 108 is coupled to the display unit 102. The bottom end 110 may include a gripping element 111 to facilitate engaging a ground surface. For example, in one embodiment the apparatus 100 may be cartable by a person across the ground surface. The bottom end 110 of the elongate shaft 106 may be oriented by the user so that the bottom end 110 engages the ground surface, thereby stabilizing and at least partially supporting the weight of the apparatus 100. The gripping element 111, which may include a rubber or plastic like coating (among other materials), may facilitate the engagement between the apparatus 100 and the ground surface and may prevent inadvertent slippage of the bottom end 110 of the elongate shaft 106 across the ground surface. In another embodiment, the gripping element 111 is a spike or a stake that can be driven into the ground.

As described above, in one embodiment the apparatus is configured to be carried by a user. Accordingly, the material of the various components 102, 104, 106 of the apparatus 100 may be selected to be rigid/strong enough to support the weight of the apparatus while still being light enough for a person to carry around. For example, the components 102, 104, 106 of the apparatus 100 may be constructed from metal, composite, polymer composite, plastic, wood, etc. The cross-section of the elongate shaft 106 may have various shapes, such as circular (i.e., a cylindrical shaft), rectangular, triangular, etc. In one embodiment, the elongate shaft 106 may not have a substantially uniform cross-sectional shape and/or may include various user handles, grasping regions, and/or ergonomic features that improve the ability of the user/carrier to heft and cart the apparatus 100.

In one embodiment, the display unit 102 may at least be constructed partially from or at least lined with deformable cushion-like material to prevent injury to adjacent people or damage to adjacent property in the event that the apparatus 100 falls over. For example, the exterior surfaces of the display unit 102 may be lined with foam-like material or cushions. In another embodiment, the corners of the display unit 102 may be rounded or tapered.

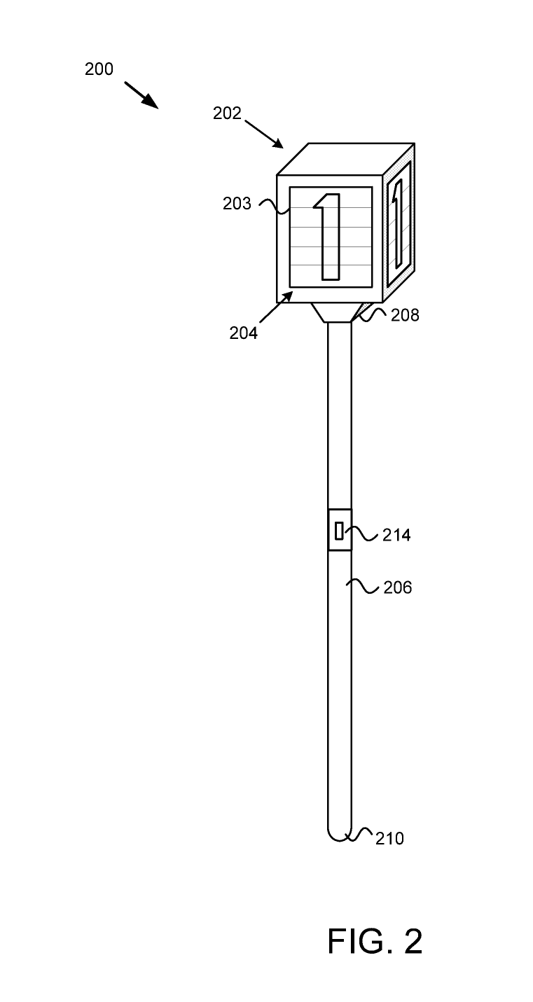

FIG. 2 is a perspective view of another embodiment of the status indicator apparatus 200. The actuatable indicators of the display element 204 of the apparatus 200 may include slats that are configured to toggle through various orientations in order to display a set of statuses. For example, the apparatus 200 may be implemented as a football down marker at a football game and the actuatable indicators coupled to each display region 203 of the display unit may be slats that are actuatable to display the numbers 1, 2, 3, or 4. In one embodiment, the apparatus 200 may be configured to not only display a single status related to an event, but the apparatus may be configured to display a second status relating to the same event. For instance, continuing the example of the football game event, the engaged position/location of the bottom end 210 of the elongate shaft 106 across the ground surface may be the second status in that it shows where the line of scrimmage is along a longitudinal direction of a football field. In other words, the apparatus may be used in conjunction with conventional ‘10-yard first down markers’ (e.g., the bottom ends of two apparatus' may be coupled together with 10 yards of chain interposed between them).

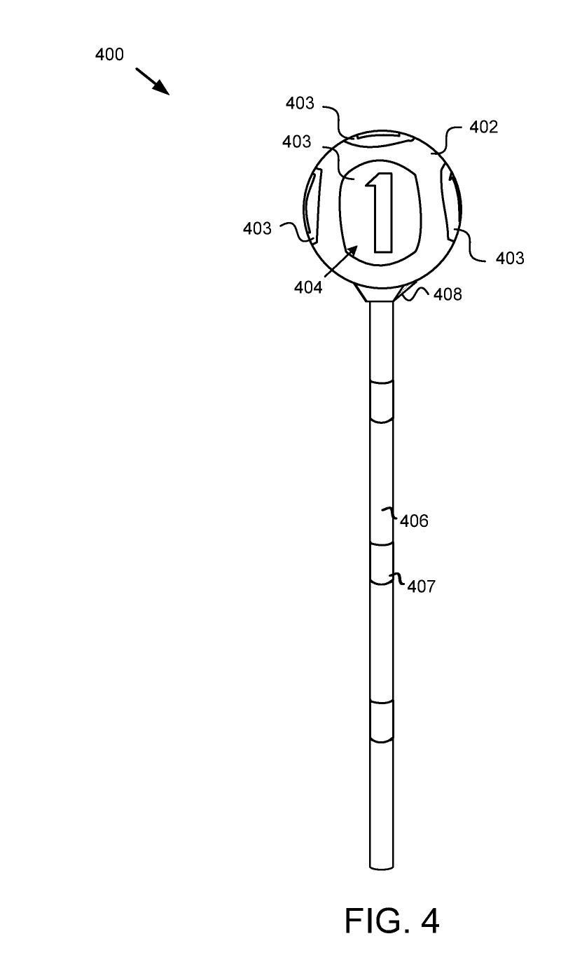

According to other embodiments, the apparatus may indicate other statuses. In the football example, the apparatus may display the play cock, the game clock, how many timeouts are remaining, the yard-line position of the ball/line of scrimmage, the remaining distance to go for a first down/goal, the score of the game, etc. In another embodiment, the apparatus may be configured to display advertisements, event specific promotions, and/or general event information. Additional details relating to the different types of information that can be indicated with the apparatus are included below with reference to FIG. 4.

The apparatus 200 may further include a switch 214 or other such mechanism that a user may engage in order to actuate the display element 204. The position of the switch 214, either disposed along the elongate shaft 206 or disposed on the display unit 202, may be selected according to the specifics of a given application. In one embodiment, the switch 214 may be electrical and corresponding electrical wires may run through the elongate shaft 106 to the display element 204. In another embodiment, the switch 214 may be mechanical and may include cams, rods, shafts, and/or other structural members mechanically coupled to the display element 204.

In one embodiment, the apparatus 200 may include an electronic communication module (not depicted) that receives actuation commands from a master controller or from a remote user (i.e., not the user carrying the apparatus). In other words, the communication module may allow for a remote controller or a remote user to control the actuation of the status indicators of the display element 204. For instance, continuing the example of the football game event, a referee or other administrator of the game may determine and select the current down of a football play. The selected, current down may be reported/communicated, via hard-wire, wireless, RF signal, etc., to the communication module of the apparatus 200 to actuate the display element 204 to display the indicated status (i.e., down). In one embodiment, one of the referees may include a wireless controller that allows him/her to select the current down, and such selection may be automatically communicated to the apparatus 200 for display.

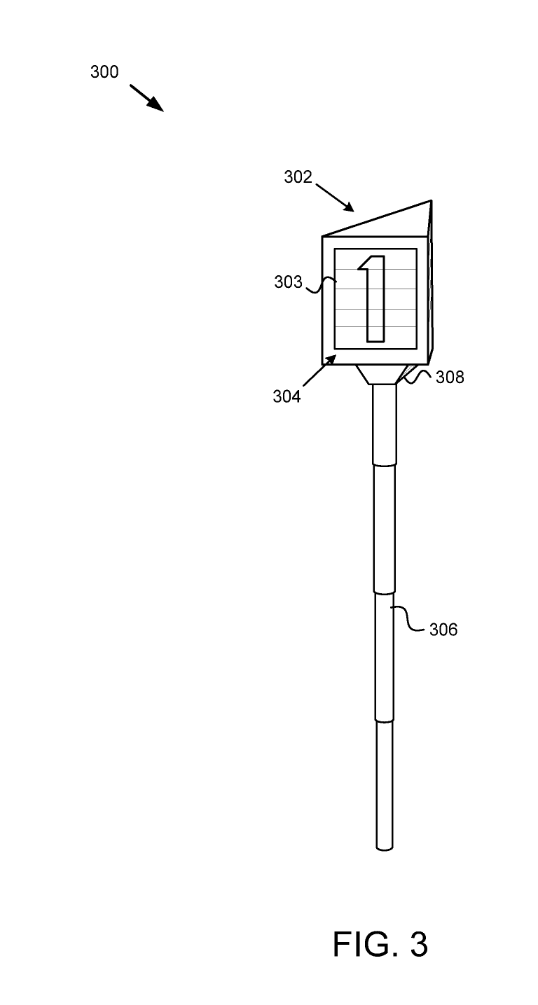

FIG. 3 is a perspective view of another embodiment of the status indicator apparatus 300. The display unit 302 may be triangular and may include three lateral surfaces, each with a display region 303 to which the actuatable indicators of the display element 304 are coupled. In one embodiment, the elongate shaft 306 may have a telescoping structure that allows the apparatus 300 to be collapsible. In another embodiment, the display unit 302 may be detachably coupled to the top end 308 of the elongate shaft 306 to further allow the apparatus 300 to be broken down for easy transportation/storage.

FIG. 4 is a perspective view of yet another embodiment of the status indicator apparatus 400. The display unit 402 may be spherical and may include various display regions 403 disposed around the exterior surface of the spherical display unit 402. In one embodiment, the apparatus 400 may include a display region on a top region of the display unit 402 to allow for people situated at the event in a position/location substantially elevated with respect to the ground surface to still view the status indicator. The display element 404 may include a banner that wraps around the display unit 402. For example, the display element 404 may be detachably fastened to the exterior surface of the display unit 402 to allow the user to manually switch the attached banner to display a different indicator. In one embodiment, the display element 404 may be attached using a hook-and-loop type fastener material, magnetic materials, adhesive materials, etc.

The actuatable indicators of the display element 404 may display numbers, letters, phrases, pictures, symbols, images, logos, etc. FIG. 4 also shows one embodiment of the elongate shaft 406 that is modular. In one embodiment, the elongate shaft 406 may include a plurality of sections that are coupleable together by coupling elements 407. In such an embodiment, the elongate shaft 406 is collapsible/foldable for storage/transportation and may be configured to have a custom length that is specific to a certain application. For example, comparatively more sections can be coupled together to form the elongate shaft 406 for applications that require the display unit 402 to be positioned comparatively higher from the ground surface.

In one embodiment, the statuses displayed by the actuatable indicators of the display element are specifically associated with specific, individual display regions of the display unit. In other words, different sides/regions of the display unit may be configured to display (via the actuatable indicators of the display element) different types of information. In the football example, the display regions (e.g., sides of the display unit) facing the field of play (i.e., the display regions of the display unit that are viewable by the players) may display one or more statuses that are relevant and/or useful to the active players while other display regions (e.g., sides of the display unit) facing away from the field of play (i.e., the display regions of the display unit that are viewable by the bench players, coaching staff, and/or spectators) may display certain statuses that are relevant/pertinent to the bench players, coaching staff, and/or spectators. In other words, the type of information indicated by the actuatable indicators in each display region may be dependent on who is expected to view each display region. In one embodiment, for example, the display element on the display region(s) facing the active players on the field may indicate the “down” of the subsequent play and/or the play clock while other display regions facing the bench players, coaching staff, and or spectators may indicate additional information, such as the “down and distance”, the number of time-outs remaining, etc. The inclusion of such information on the portable display indicator apparatus' may allow for visiting teams, for example, to quickly and easily ascertain in-game information and statuses relating to the game without having to look around the stadium and familiarize oneself with the home team's scoreboard.

In another example, each team may be allowed to customize and control the information that is being indicated by the apparatus' on its respective sideline. For example, the apparatus may be configured to indicate which play is being called (offensively or defensively) and/or to indicate certain player packages/formations. Using such a system, coaches may be able to quickly and efficiently communicate player substitutions and/or communicate player formations, etc.

As mentioned above, different control entities may have control over the display element to effectuate the actuatable indicators. In one embodiment, for example, multiple entities may have access to send instructions to a status indicator apparatus. In the football example, the referee (or box referees) may have control over the ‘down’ information, the play-clock, the game-clock, the score, etc., while coaches may have control over other types of information, such as the play being called, the player package required, etc. Further, stadium/event administrators may also have control over other types of information that can be communicated to and displayed by the status indicator apparatus.

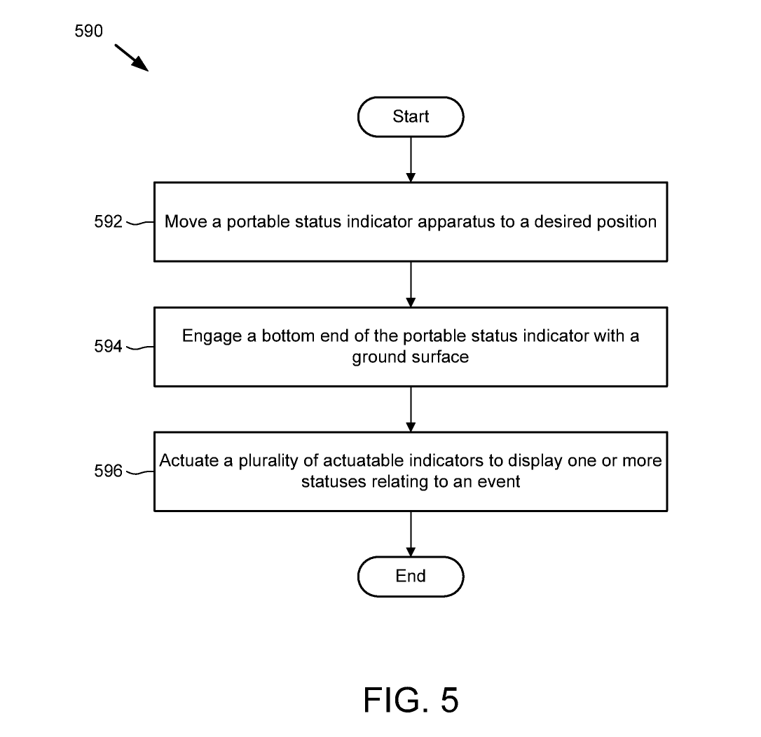

FIG. 5 is a schematic flowchart diagram of one embodiment of a method 590 for indicating one or more statuses relating to an event. The method 590 includes moving a portable status indicator apparatus to a desired position relative to a ground surface of the event. For example, the method 590 may include moving 592 the portable status indicator apparatus to a desired position along a sideline of a football field, with the desired position along the sideline indicating the position of the line of scrimmage (i.e., a status of the event). The portable status indicator apparatus includes a display unit coupled to a top end of an elongate shaft. The method 590 further includes engaging 594 a bottom end of the elongate shaft of the portable status indicator apparatus with the ground surface at the desired position and actuating 596 a plurality of actuatable indicators to display the one or more statuses relating to the event. Each of the actuatable indicators of the plurality of actuatable indicators is coupled to a display region of the display unit and the display regions are cumulatively viewable from 360 degrees around the display unit.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A status indicator apparatus comprising:
a display unit comprising a plurality of display regions, wherein the plurality of display regions are cumulatively viewable from 360 degrees around the display unit;
a display element comprising a plurality of actuatable indicators for displaying a status relating to an event, wherein each actuatable indicator of the plurality of actuatable indicators is coupled to a display region of the plurality of display regions; and
an elongate shaft comprising a top end and a bottom end, wherein the display unit is coupled to the top end.

2. The apparatus of claim 1, wherein the bottom end of the elongate shaft is operably engageable at a certain location across a ground surface, wherein the status of the event is a first status of the event, wherein the certain location of the bottom end of the elongate shaft across the ground surface relates to a second status of the event.

3. The apparatus of claim 2, wherein the event comprises a football game and the first status comprises a down of a football play and the second status comprises a position of a line of scrimmage of the football play.

4. The apparatus of claim 1, wherein the bottom end comprises a gripping element for gripping the ground surface.

5. The apparatus of claim 1, wherein the elongate shaft comprises a telescoping structure such that the elongate shaft is collapsible.

6. The apparatus of claim 1, wherein the elongate shaft comprises a folding structure such that the elongate shaft is foldable.

7. The apparatus of claim 1, wherein the elongate shaft is detachably coupled to the display unit.

8. The apparatus of claim 1, wherein the display element comprises a plurality of light emitting diodes (LEDs).

9. The apparatus of claim 8, wherein the plurality of LEDs are powered by one or more of a battery and a solar panel, the solar panel being disposed on a top of the display unit.

10. The apparatus of claim 8, wherein the plurality of LEDs are recessed in relation to an exterior surface of the display unit such that the LEDs do not protrude beyond the exterior surface.

11. The apparatus of claim 1, wherein the display element comprises a plurality of slats controlled by a lever.

12. The apparatus of claim 1, wherein the display element comprises a banner that wraps around each display region.

13. The apparatus of claim 1, wherein the display unit comprises a substantially cubical shape having a top side, a bottom side, and four lateral sides perpendicular to the top and bottom sides, wherein each lateral side of the four lateral sides is a display region of the plurality of display regions.

14. The apparatus of claim 13 wherein the top side is also a display region of the plurality of display regions.

15. The apparatus of claim 1, further comprising a controller configured to receive instructions and control the plurality of actuatable indicators based on the instructions.

16. The apparatus of claim 15, wherein the controller receives the instructions wirelessly from one or more control entities.

17. The apparatus of claim 1, wherein the display element displays multiple statuses relating to an event.

18. The apparatus of claim 17, wherein each status is specific to one or more of the display regions.

19. A status indicator apparatus comprising:
a display unit comprising a plurality of display regions;
a display element comprising a plurality of actuatable indicators for displaying multiple statuses relating to an event, wherein each actuatable indicator of the plurality of actuatable indicators is coupled to a display region of the plurality of display regions, wherein each status is specific to one or more of the display regions;
an elongate shaft comprising a top end and a bottom end, wherein the display unit is coupled to the top end; and
a controller configured to receive instructions from one or more control entities to control the plurality of actuatable indicators in displaying the multiple statuses, wherein each status is specific to one or more of the control entities.

20. A method for indicating one or more statuses relating to an event, the method comprising:
moving a portable status indicator apparatus to a desired position relative to a ground surface of the event, wherein the portable status indicator apparatus comprises a display unit coupled to a top end of an elongate shaft;
engaging a bottom end of the elongate shaft of the portable status indicator apparatus with the ground surface at the desired position; and
actuating a plurality of actuatable indicators to display the one or more statuses relating to the event, wherein each of the actuatable indicators of the plurality of actuatable indicators is coupled to a display region of the display unit, wherein the display regions are cumulatively viewable from 360 degrees around the display unit.
